(19) United States
(12) Patent Application Publication
(10) Pub. No.: US 2007/0017998 A1
(43) Pub. Date: Jan. 25, 2007

(54) Portable data collection system and method for inventory management utilizing same

(76) Inventor: Michael A. Sears, Lake Havasu City, AZ (US)

Correspondence Address: MESCHKOW & GRESHAM, P.L.C., 5727 NORTH SEVENTH STREET, SUITE 409, PHOENIX, AZ, 85014, US

(21) Appl. No.: 11/190,100

(22) Filed: Jul. 25, 2005

(51) Int. Cl. G06K 7/10; G06Q 30/00

(52) U.S. Cl. 235/462.45; 235/462.46; 235/385

(57) ABSTRACT

A portable data collection system (20) includes a wireless microphone (24) for receiving voice signals (40) identifying an item (52), and an enclosure housing an optical scanner (30), an actuator (28), a microprocessor (44), and memory (48). The actuator (28) concurrently actuates the optical scanner (30) and receives the voice signals (40). The optical scanner (30) reads a barcode identifier (56) from a barcode label (54) coupled to the item (52). A microprocessor (44) executes a voice recognition program (60) that interprets the voice signals (40) to form a data record (62) corresponding to the item (52). The data record (62), linked with the barcode identifier (56), forms a database entry (64) stored in an inventory database (66) in memory element (48). The inventory database (66) is utilized in an inventory management process (94) when relocating items from an origination site to a destination site.

### TECHNICAL FIELD OF THE INVENTION

The present invention relates to the field of portable data collection systems. More specifically, the present invention relates to a portable data collection system for use in inventory management that links a barcode identifier for an item with a verbal description of the item.

### BACKGROUND OF THE INVENTION

A relocation company, or mover, is a company that moves the possessions of a family or business from an origination site to a destination site. Per conventional procedure, when representatives of the relocation company arrive at the origination site, they prepare items and cartons for shipment. Preparation entails, among other things, generating a detailed inventory of the possessions, or items, to be moved. The inventory is subsequently approved by the client (i.e., a family member or business owner) and copies are provided to the authorized parties (i.e., the client, the driver of the vehicle moving the possessions, and the relocation company) before the possessions can be relocated. The inventory establishes liability if damage is claimed at the destination site.

The inventory typically includes an identifier for each item or carton, a brief description of the item, and any exceptions. An “exception” in the relocation industry points out the current condition of an item, such as scratches, chips, dents, and so forth. Typically, the inventory is generated manually by a shipping company representative who writes down an item's identifying number, description, and any exceptions. For brevity, the description and/or exceptions may be recorded in code form, rather than the local language.

Manual entry of inventory information is time consuming for the inventory taker. Moreover, while that representative is writing down the information, other representatives may be idle, simply waiting for the inventory to be taken. Consequently, this method of generating an inventory is quite time consuming and costly in terms of labor dollars spent. In addition, manual entry of inventory information can lead to errors in description and/or when interpreting a hand-written entry. This is especially problematic because typical relocation company policy calls for the client to be sure that each item is tagged and that the inventory is complete and accurate. When the hand-writing is difficult to read and/or numerical codes are used to represent exceptions, the client cannot be sure that accurate information is actually being recorded on the inventory.

Portable data collection terminals, including barcode readers and keypads integrated into the terminal, are used for inventory management and control. The form of such terminals varies but many generally include a trigger operated scanner and a keypad on the surface of the scanner housing. In general operation, a user may scan a barcode on an item and then be prompted to take various actions pertinent to inventory control. In a data collection mode, the user may enter information regarding the item by either scanning one or more barcodes using the barcode scanner, or by keying in the information using the keypad. As the data is collected, it is stored in memory for later upload into a remote device.

Hand-held portable data collection terminals have not been incorporated into the inventory management procedures employed by relocation companies for a number of reasons. In general, such portable data collection terminals are undesirably complex for use by workers of a relocation company and manual entry of inventory data via a keypad is cumbersome. In addition, some portable data collection terminals have various tethered accessories, such as headsets, microphones, and scanning wands coupled thereto that can become tangled, damaged, and or lost.

Accordingly, what is needed is an accurate and efficient method for generating an inventory of a plurality of items, such as the possessions to be moved from an origination site to a destination site. What is further needed is a portable data collection system that can be incorporated into the inventory management procedures employed by relocation companies that is simple to use, accurate, durable, and low cost.

### SUMMARY OF THE INVENTION

Accordingly, it is an advantage of the present invention that a portable data collection system and method for inventory management are provided.

It is another advantage of the present invention that the portable data collection system and method for its use are provided which yield an accurate inventory of a plurality of items.

Another advantage of the present invention is that a portable data collection system and method for its use are provided that can be incorporated into the inventory management procedures employed by relocation companies.

Yet another advantage of the present invention is that a portable data collection system is provided that is simple to use, durable, and low cost.

The above and other advantages of the present invention are carried out in one form by a portable data collection system for associating a barcode identifier with an item. The system includes a microphone for receiving voice signals identifying the item and an optical scanner for reading the barcode identifier from a barcode label coupled to the item. An actuator concurrently actuates the optical scanner and enables receipt of the voice signals. A microprocessor is in communication with each of the microphone, the optical scanner, and the actuator. The microprocessor executes a voice recognition program that interprets the voice signals to form a data record corresponding to the item. A memory element is associated with the microprocessor for storing the data record linked with the barcode identifier.

The above and other advantages of the present invention are carried out in another form by a method for inventory management of a plurality of items utilizing a portable data collection system. The method calls for generating, in a memory element of the data collection system, a database that includes an inventory of the plurality of items. For each of the plurality of items, the generating operation includes reading a barcode identifier from a barcode label coupled to the item via an optical scanner of the data collection system, and receiving voice signals identifying the item via a wireless microphone in radiofrequency communication with the data collection system. The voice signals are interpreted at the data collection system by executing a voice recognition program to form a data record corresponding to the item. The data record linked with the barcode identifier for the item is stored in the database, and the database is provided to a user for use in the inventory management.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a portable data collection system in accordance with a preferred embodiment of the present invention;

FIG. 2 shows a block diagram of the portable data collection system of FIG. 1;

FIG. 3 shows a flowchart of a system control process performed by the portable data collection system of FIG. 1;

FIG. 4 shows a flowchart of an inventory management process utilizing the portable data collection system of FIG. 1 in accordance with the present invention;

FIG. 5a-c show a schematic view of the presentation of an exemplary barcode identifier and a data record describing an item on a display of the portable data collection system of FIG. 1; and

FIG. 6 shows a table of an exemplary inventory database generated through the execution of the inventory management process.

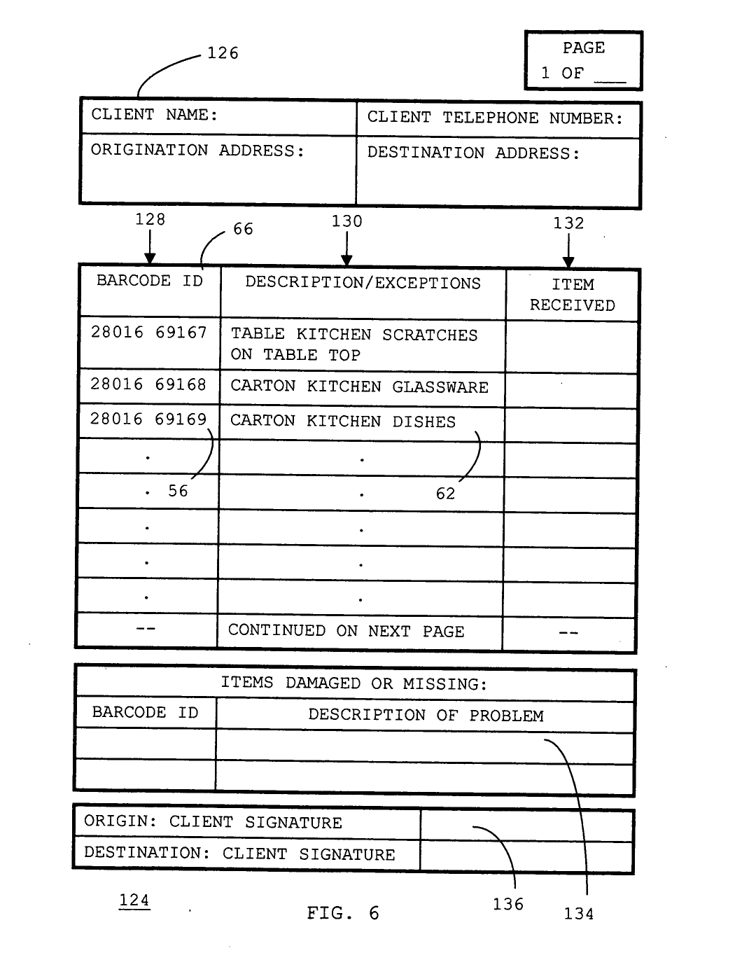

### DETAILED DESCRIPTION OF THE PREFERRED EMBODIMENTS

The present invention entails a portable data collection system and a method for inventory management utilizing the portable data collection system. The present invention is described in connection with its incorporation into the inventory management procedures employed by a relocation company. However, it should become apparent that the portable data collection system and methodology described herein may be adapted for use in a variety of businesses for inventory control and management.

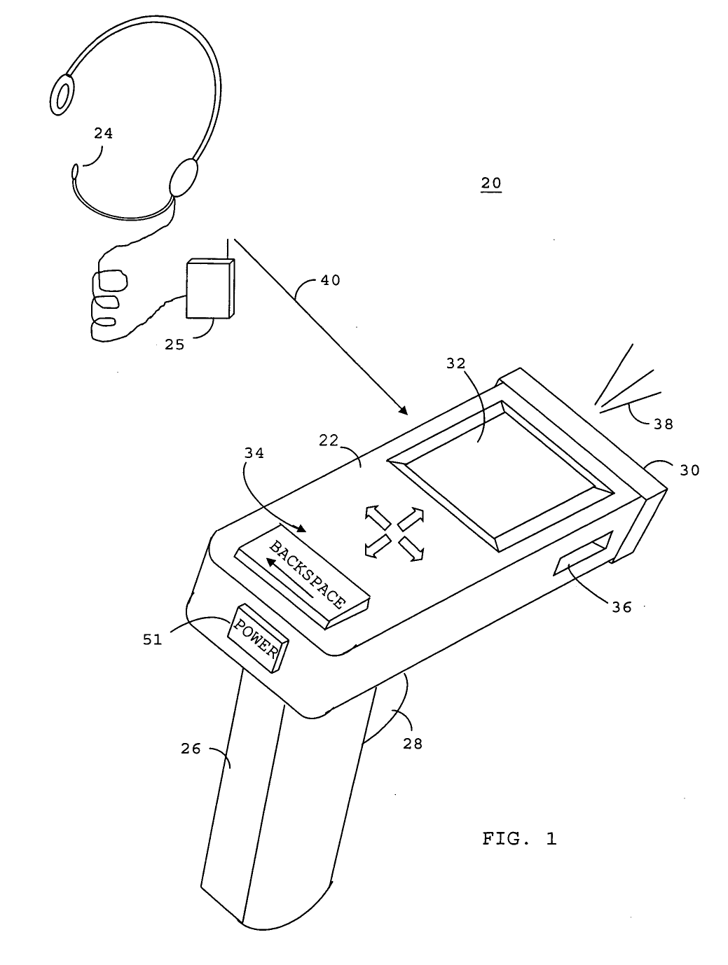

FIG. 1 shows a perspective view of a portable data collection system 20 in accordance with a preferred embodiment of the present invention. Portable data collection system 20 includes a handheld enclosure 22 and a wireless headset microphone 24 with a corresponding transmitter 25. Transmitter 25, which may be worn on the belt or an armband of a user, is in radiofrequency communication with a receiver (discussed below) housed within handheld enclosure 22.

Handheld enclosure 22 includes a pistol grip handle 26 shaped to fit the hand of a user, and an actuator, in the form of a manually actuated trigger 28 extending through enclosure 22, for activating data collection system 20. Handheld enclosure 22 of system 20 further includes an optical scanner 30, a display 32, a keypad 34, and a data port 36 that provide capability for collecting, viewing, modifying, and downloading data (discussed below).

In general, when trigger 28 is actuated by a user, a beam of light 38 is emitted from optical scanner 30. Beam of light 38 scans a barcode label (not shown) and reads a barcode identifier per conventional techniques. Concurrent with reading the barcode identifier, voice signals, represented by an arrow 40, received at microphone 24 are transmitted from transmitter 25 and received at the receiver (discussed below) housed within handheld enclosure 22. Voice signals 40 are interpreted by circuitry and processes operable within handheld enclosure 22 and are linked with the barcode identifier.

In one application of the present invention, portable data collection system 20 may be utilized by representatives of a relocation company for inventory management of a plurality of items that are to be moved from an origination site to a destination site. As will be discussed below, the barcode identifier can be used to uniquely identify one of the plurality of items, and voice signals 40 can provide a verbal description of the particular item. The barcode identifier and linked voice signals 40 subsequently form a data record for entry into an inventory database. The data record, i.e., the barcode identifier and linked voice signals 40, may be presented on display 32 for review and may optionally be modified using keypad 34. In addition, the inventory database may be downloaded for printing and provision to the client, i.e., a family member or business owner, the driver of the vehicle moving the possessions, and the relocation company via data port 36.

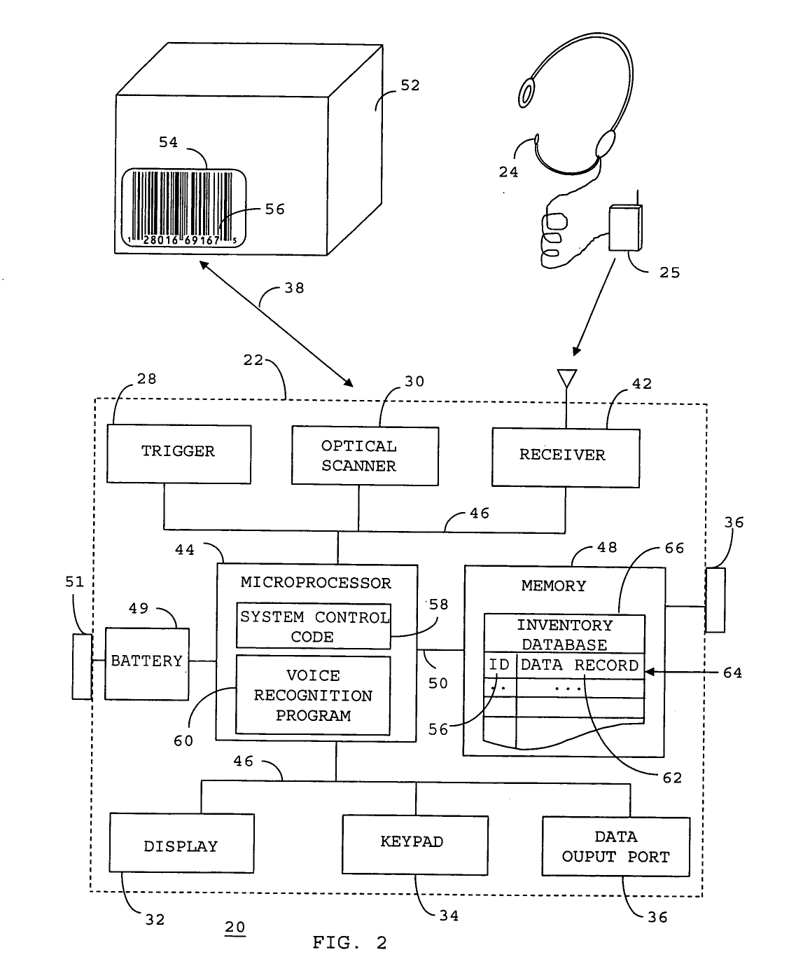

Referring to FIG. 2 in connection with FIG. 1, FIG. 2 shows a block diagram of portable data collection system 20. Portable data collection system 20 generally includes trigger 28, optical scanner 30, and a receiver 42 each of which are in communication with a microprocessor 44 via a bus structure 46. System 20 further includes a memory element 48 associated with microprocessor 44 via a data bus 50. In addition, display 32, keypad 34, and data output port 36 are each in communication with microprocessor 44 via bus structure 46. Portable data collection system 20 further includes a power source, such as a battery 49. A power switch 51, for connecting battery 49 to the electronic components of portable data collection system 20, is mounted on enclosure 22. System 20 is preferably battery operated for portability, using one or more battery cells. In a preferred embodiment, optical scanner 30, receiver 42, microprocessor 44, bus structure 46, memory element 48, data bus 50, and battery 49 are housed within handheld enclosure 22.

An item 52 is also shown in FIG. 2. Item 52 represents one of a plurality of items for which an inventory is to be taken. The plurality of items may be the items within a household or business that are to be relocated from an origination site to a destination site. Item 52 is generally illustrated as a rectangular element for simplicity of illustration. However, it should be understood that item 52 can be any of a variety of shapes and sizes depending upon the nature of the furniture, carton sizes, and so forth. It should be further understood that item 52 may be a box or carton filled with a plurality of articles. However, this plurality of articles constitutes only one item 52 by virtue of their storage into a single box or carton.

Item 52 has a barcode label 54 attached thereto. In a preferred embodiment, barcode labels, such as barcode label 54, are coupled to each item of the plurality of items to be relocated by representatives of the relocation company. Each barcode label 54 includes a unique barcode identifier 56. Barcode identifier 56 includes a combination of bars and spaces of varying widths that represent a reference number. Typically, a computer uses this reference number to look up an associated data record that contains descriptive data and other important information.

Conversely, and in accordance with the current invention, when barcode label 54 is initially attached to item 52, barcode identifier 56 is unassigned. That is, barcode identifier 56 does not have an associated data record that contains descriptive data of item 52. Rather, by utilizing portable data collection system 20, the relocation representative will generate a data record containing descriptive data of item 52 and system 20 will link that data record to barcode identifier 56 (discussed below).

Barcode identifier 56 is illustrated as the commonly utilized series of vertical bars of varying widths, in which each of the digits zero through nine are represented by a different pattern of bars that can be read by optical scanner 30. The bars are commonly found on consumer products and are used especially for inventory control. However, the present invention need not be limited to such a barcode identifier 56. Rather, other current and upcoming barcode patterns may be employed such as other linear barcodes, concentric circles, a grid of square cells, and so forth.

Optical scanner 30 generally includes a light source for emitting beam of light 38, a lens, a photo conductor translating optical impulses into electrical ones, and decoder circuitry for decoding barcode identifier 56. In an exemplary embodiment, optical scanner 30 is a laser barcode scanner capable of scanning barcode identifier 56 at a distance of up to approximately ten inches. However, the present invention need not be limited to a laser barcode scanner, but may instead utilize other current and upcoming light sources, such as photo conductor, charge coupled device (CCD), and the like.

Receiver 42 is tuned to receive radiofrequency voice signals 40 transmitted from transmitter 25. Wireless headset microphone 24 with transmitter 25 and receiver 42 can be adapted from any of a number of conventional wireless headset systems. Wireless headset 24 and transmitter 25 are worn by the inventory taker, typically a representative of the relocation company. A wireless system is preferred so that handheld enclosure 22 and wireless headset 24 need not be physically coupled. With no physical coupling, handheld enclosure 22 can freely move about so that optical scanner 30 can be positioned in an optical location for scanning barcode identifier 56. Moreover, no physical coupling is advantageous over physical coupling because physical coupling could lead to tangled and/or damaged wires, and decreased user mobility. Although a wireless system is preferred, the present invention could be adapted to include a wired headset microphone that plugs directly into a port provided in enclosure 22, thereby removing the requirement for transmitter 25 and receiver 42.

Microprocessor 44 performs a system control process 58 in the form of executable code that controls the components housed in handheld enclosure 22 via bus structure 46. In addition, microprocessor 44 executes a voice recognition program 60. Voice recognition program 60 is software designed to recognize and respond to spoken commands through digitization and algorithm-based programming. In a preferred embodiment, voice recognition program 60 may be in the form of automatic speech recognition software, commonly referred to as dictation. Dictation is utilized to interpret voice signals 40 and identify the exact words spoken by the user, but does not require semantic understanding.

When actuation of trigger 28 is detected, through the execution of system control process 58, microprocessor 44 provides an output via bus structure 46 to actuate optical scanner 30. In addition, voice recognition program 60 is executed and microprocessor 44 enables receipt of voice signals 40. Voice signals 40 are input by a user to describe item 52. Voice signals 40 may include the item name, current location (i.e., kitchen, bedroom, livingroom, etc.), condition, and/or exceptions. Through the execution of voice recognition program 60, the spoken voice signals 40 are interpreted and converted to a digital data record 62.

In a preferred embodiment, voice signals 40 will be collected and associated with barcode identifier 56 until a next actuation of trigger 28 occurs. Such a technique is simple to utilize since the user need not remember to stop collection of voice signals 40. In an alternative embodiment, however, the user may signal data collection completion through depression of a key on keypad 34. This methodology can be repeated until all of the items having coupled barcode labels 54 have been inventoried.

Data record 62 is linked with barcode identifier 56 to form a database entry 64 which is subsequently written to an inventory database 66 in memory element 48. In a preferred embodiment, memory element 48 may be a Random-Access Memory (RAM) chip, and inventory database 66 can be read out via data output port 36. Data output port 36 may be a universal serial bus (USB) port for cabled connection with a remote device, such as a printer or computing system. Alternatively, a USB portable storage device may be coupled to data output port 36 and inventory database 66 can be downloaded to the USB portable storage device. Alternatively, data collection system 20 can include a card slot (not shown) for an external memory device, such as a personal computer (PC) card. In such a situation, the PC card could serve as memory element 48 so that inventory database 66 may be written directly to the PC card.

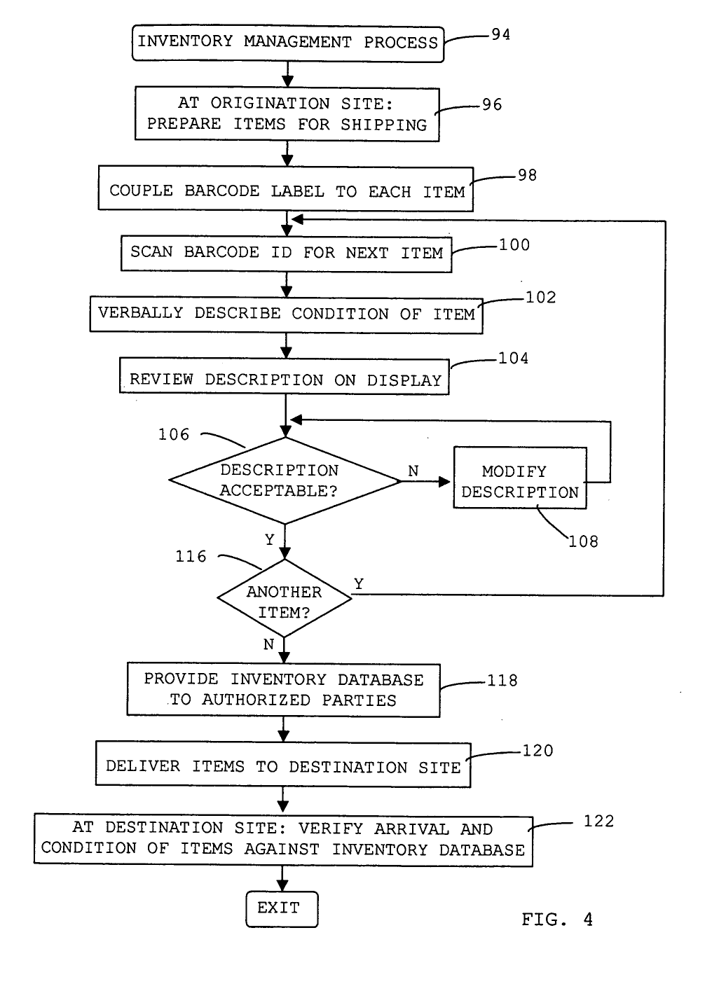

As voice signals 40 are interpreted by voice recognition program 60, the ensuing data record 62 is presented in text format along with the decoded barcode identifier 56 in display 32 so that the user can verify correct input of inventory information. Occasionally, it may become necessary to modify data record 62. For example, voice recognition program 60 may not identify the correct spelling of a spoken word, the user may wish to delete some or all of the text, or the user may wish to insert additional text. Accordingly, the presented data record 62 may be modified utilizing keypad 34. Modification of data record 62 will be discussed in further detail in connection with FIG. 4a-c.

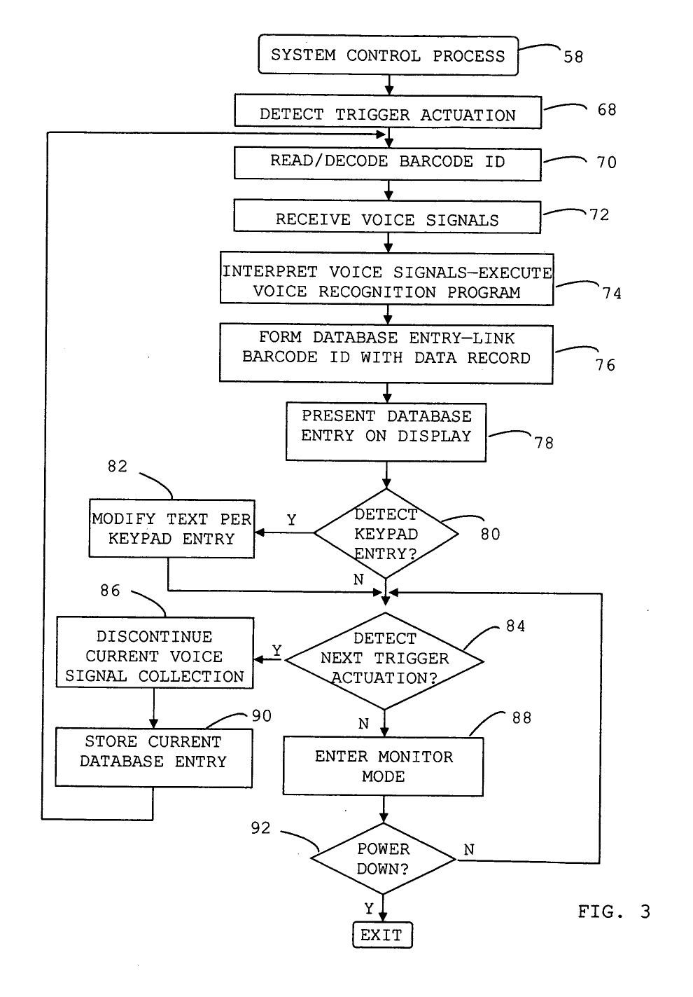

FIG. 3 shows a flowchart of system control process 58 of portable data collection system 20 (FIG. 1). As mentioned briefly above, system control process 58, in the form of executable code, is executed by microprocessor 44 (FIG. 2) to control the components housed in handheld enclosure 22. As such, the operation of portable data collection system 20 can be summarized by the flowchart of process 58.

Process 58 begins at a task 68. At task 68, microprocessor 44 (FIG. 2) detects actuation of trigger 28 (FIG. 1). In response to actuation of trigger 28, microprocessor 44 provides an output via bus structure 46 to actuate optical scanner 30 (FIG. 1) so that scanner 30 emits beam of light 38. Concurrently, microprocessor enables receipt of voice signals 40 (FIG. 1).

In response to task 68, a task 70 is performed at portable data collection system 20. At task 70, barcode identifier 56 (FIG. 2) is read and decoded at optical scanner 30.

Although shown serially, a task 72 is performed concurrent with task 70. At task 70, voice signals 40 (FIG. 1) are received.

Next, a task 74 interprets voice signals 40. That is, microprocessor 44 (FIG. 1) executes voice recognition program 40 which subsequently interprets voice signals 40 to form data record 62 (FIG. 2) describing item 52 (FIG. 2).

System control process 58 continues with a task 76. At task 76, barcode identifier 56 and data record 62 are linked to form database entry 64 (FIG. 2).

A task 78, performed in conjunction with task 76, causes database entry 64 to be presented on display 32 as voice signals are interpreted at task 74.

A query task 80 is performed in response to task 78. At query task 80, microprocessor 44 (FIG. 2) monitors for a keypad entry on keypad 34 (FIG. 1). Any keypad entries indicate a desire by the user of portable data collection system 20 to modify the currently presented data record 62. Consequently, when a keypad entry is detected at query task 80, process control proceeds to a task 82.

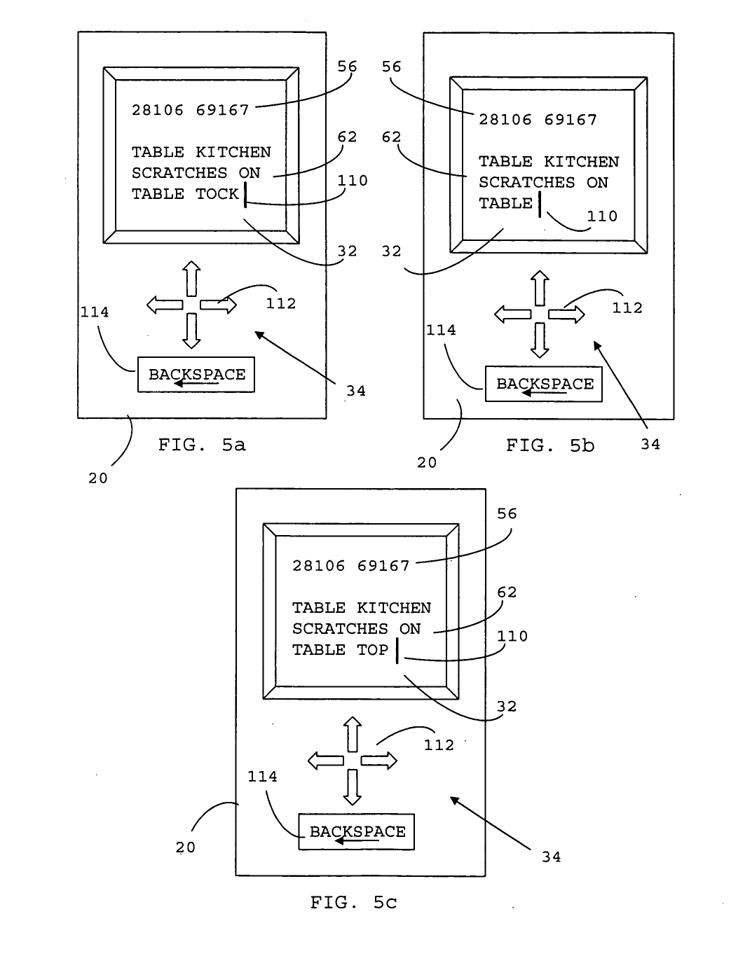

At task 82, microprocessor 44 enables modification of data record 62 in accordance with keypad entries. Text modification will be described below in connection with FIG. 5a-c.

Following text modification at task 82 or when query task 80 fails to detect a keypad entry, process control proceeds to a query task 84 to determined whether a “next” actuation of trigger 28 (FIG. 1) is detected. A “next” actuation of trigger 28 indicates the user's desire to inventory another one of the plurality of items to be inventoried. Consequently, when the next actuation of trigger 28 is detected, process 58 proceeds to a task 86. However, when a “next” actuation of trigger 28 is not detected within, for example, a predetermined amount of time, process control proceeds to a task 88 (discussed below).

At task 86, microprocessor 44 discontinues current collection of voice signals 40. That is, data collection of voice signals 40 pertaining to item 52, received at task 72 and linked with barcode identifier 56 at task 74 is discontinued.

A task 90 is performed in response to task 86. At task 90, microprocessor stores the current database entry 64 formed at task 76 and optionally modified at task 82 into inventory database 66 (FIG. 2). Process control then loops back to task 70 to read/decode the “next” barcode identifier 56 coupled to the next item 52 (FIG. 2) and repeat the data collection process for the next item 52 of the plurality of items to be inventoried.

Returning to query task 84, when a “next” actuation of trigger 28 is not detected, process control proceeds to task 88. As discussed in connection with tasks 86 and 88, data collection for a particular item 52 being inventoried is discontinued in response to the next actuation of trigger 28. However, in some instances the “next” actuation of trigger 28 may not be relatively immediate. For example, the user of system 20 may set handheld enclosure 22 (FIG. 1) down to pack up another item 52, may move to another room, and so forth. Consequently, an optional task 88 may be performed to place portable data collection system 20 (FIG. 1) in a monitor mode following a predetermined amount of time in which an actuation of trigger 28 is not detected. In a monitor mode, microprocessor 44 may discontinue receipt, interpretation of, and storage of voice signals 40 so as to save memory space and to conserve battery power.

In response to task 88, a query task 92 monitors for power down signaling. Power down is accomplished when the user of system 20 (FIG. 1) actuates power switch 51. When query task 92 fails to detect power down signaling, process 58 loops back to query task 84 to determine whether a next actuation of trigger 28 is detected. However, when query task 92 detects a power down of system 20, system control process 58 exits. Through the execution of system control process 58, an inventory of items to be moved from an origination site to a destination site is readily and accurately generated and stored as inventory database 66 (FIG. 2).

FIG. 4 shows a flowchart of an inventory management process 94 utilizing portable data collection system 20 (FIG. 1) in accordance with the present invention. Inventory management process 94 describes generalized methodology followed by representatives of a relocation company utilizing system 20 to generate inventory database 66 (FIG. 2) at an origination site, and to utilize inventory database 66 at a destination site.

Process 94 begins at a task 96. At task 96, one or more representatives of the relocation company arrive at the origination site, i.e., the site from which the items are to be moved. The representatives then prepare the items for shipping per conventional procedures, i.e., packing individual articles into cartons, disassembling furniture, taking down wall hangings and wrapping them, and so forth. A task 98 is performed in conjunction with task 96. At task 98, a unique barcode label 54 (FIG. 2) is coupled to each item 52 (FIG. 2).

Subsequent tasks utilize portable data collection system 20 (FIG. 1) to scan barcode label 54 and verbally describe each item 52 so as to inventory the items prior to shipment. Tasks 96, 98, and subsequent tasks utilizing system 20 are described herein as occurring serially for simplicity of illustration. However, those skilled in the art will recognize these tasks are not necessarily performed serially, but are likely to occur in parallel. For example, a representative may prepare item 52 for shipping (task 96), couple barcode label 54 to item 52 (task 98), and immediately perform subsequent tasks utilizing portable data collection system 20 prior to performing the same tasks for the next item.

With continued reference to inventory management process 94, in response to tasks 96 and 98, a task 100 is performed by the user, i.e., the inventory taker, representing the relocation company. At task 100, the user begins data collection by scanning barcode label 54 coupled to the next item 52. It should be understood herein, that during a first iteration of task 100, the “next” item 52 is a first item, and any subsequent items 52 to be inventoried are thereafter the “next” item. At task 100, the user activates trigger 28 (FIG. 1), which causes optical scanner 30 to emit beam of light 38 to read barcode identifier 56, as discussed in detail above. Activation of trigger 28 further causes microprocessor (FIG. 2) to enable receipt and interpretation of voice signals 40 (FIG. 1) through execution of voice recognition program 60 (FIG. 2), again as discussed in detail above.

In response to task 100, a task 102 is performed. At task 102, the user verbally describes item 52 into microphone 24 (FIG. 1). This verbal description desirably includes the item name, current location (i.e., kitchen, bedroom, livingroom, etc.), condition, and/or exceptions. As the verbal description of item 52 is provided, system 20 interprets and converts the spoken voice signals 40 to digital data record 62 through the execution of voice recognition program 60. Data record 62 is presented in text format along with the decoded barcode identifier 56 (FIG. 2) on display 32 (FIG. 1).

A task 104 is performed in response to task 102. At task 104, the inventory taker reviews data record 62 on display 32 so that the inventory taker can verify correct input of inventory information.

Next, at a query task 106, the user determines whether the verbal description, i.e., the text format of data record 62, is acceptable. When the verbal description is not acceptable, i.e., when there are dictation errors, or information needs to be added or deleted, process 94 proceeds to a task 108. At task 108, the user modifies the description via keypad 34 (FIG. 1). Process control loops back to query task 106 to subsequently determine whether the verbal description is acceptable following modification task 108.

Referring to FIG. 5a-c in connection with task 108, FIG. 5a-c show a schematic view of the presentation of exemplary barcode identifier 56 and data record 62 describing item 52 (FIG. 2) on display 32 of portable data collection system 20. Although highly simplified, FIG. 5a-c illustrates how data record 62 may be modified in accordance with the present invention.

As shown in FIG. 5a, data record 62 presented on display 32 reveals an incorrectly dictated word, i.e., “tock.” An exemplary cursor 110 is shown in display 32 at the end of data record 62. Typically, such a cursor 110 is represented by a blinking vertical line. Cursor 110 indicates an insertion point, displayed when editing data record 62, to show the location of any further modification.

In accordance with familiar computer keyboard configurations, keypad 34 includes navigational arrows 112 for moving cursor 110 up, down, right, and left within data record 62. Keypad 34 further includes a backspace key 114 also typically found in conventional computer keyboard configurations. Using navigational arrows 112, a user can move cursor 110 to the desired location for text modification, which can be anywhere within data record 62. The user can then actuate backspace key 114 to optionally delete some or all text within data record 62. The user can then verbally enter the appropriate information via microphone 24 (FIG. 1). Alternatively, the user can move cursor 88 to the desired location and insert additional information by verbally entering the information via microphone 24 (FIG. 1), without having first deleted any text within data record 62. The information is subsequently interpreted at microprocessor 44 (FIG. 2) through execution of voice recognition program 60 (FIG. 2) and is inserted into data record at the current location of cursor 88.

As shown in FIG. 5b, the user has actuated backspace key 114 and deleted the incorrectly dictated word “tock.” The user can now insert the correct word “top” by verbalizing the word into microphone 24. The correctly verbalized word is then inserted into data record at the current location of cursor 88, as represented in FIG. 5c. The features of simple navigational arrows 112 combined with backspace key 114 and verbal entry of descriptive information results in very simple keypad configuration. The simple keypad configuration is easily learned and significantly less cumbersome to utilize then conventional text keyboards.

With reference back to query task 106 of FIG. 4, when the user determines at query task 106 that the verbal description is acceptable with or without having performed modification task 108, process control proceeds to a query task 116. At query task 116, the user determines whether all items have been inventoried. When there is another item 52 (FIG. 2) to be inventoried, inventory management process 94 loops back to task 100 to repeat inventory process tasks for the next item 52. However, when there are no further items to be inventoried, inventory management process 94 proceeds to a task 118.

At task 118, inventory database 66 (FIG. 2), generated through the implementation of inventory process tasks 100, 102, 104, 106, 108, and 116, is provided to any authorized parties. In an exemplary embodiment, inventory database 66 may simply be downloaded via data port 36 (FIG. 1) to a printer (not shown) where inventory database 66 is printed out. Alternatively, inventory database 66 may be downloaded to a computer system, such as a laptop, where it can first be reviewed and optionally edited prior to printing it out and distributing it to authorized parties. Per conventional procedures, inventory database 66 is reviewed and approved by the client, i.e., a family member or business owner. Copies are then provided to the authorized parties, which may encompass the client, the driver of the vehicle moving the possessions, and the relocation company.

Following task 118, a task 120 is performed by the relocation company representatives to deliver the plurality of items to a destination site per conventional procedures.

Once the items have been delivered to the destination site in accordance with task 120, a task 122 is performed at the destination site. At task 122, the relocation company representatives unload the shipped items. An authorized party, typically the client, i.e., a family member or business owner, then verifies arrival and condition of the items against inventory database 66. Per conventional procedures, the client should inspect the items that have been shipped for damage and note their condition on arrival, and any damage or losses should then be recorded for processing through an insurance carrier. Following task 122, inventory management process 94 exits.

FIG. 5 shows a table of an exemplary inventory document 124 generated through the execution of inventory management process 94 (FIG. 4). Exemplary inventory document 124 includes header information 126 that may contain client identification information, such as client name, client telephone number, origination address, and destination address. Inventory document 124 further includes inventory database 66 generated with the use of portable data collection system 20 (FIG. 1). As shown, inventory database 66 includes a barcode identifier field 128 containing unique barcode identifiers 56, a data record field 130 containing data records 62 linked with barcode identifiers 56, and an item received field 132. Item received field 132 may be marked as the client verifies receipt of each item at the destination site at task 122 (FIG. 4) of inventory management process 94 (FIG. 4).

Inventory document 124 further includes a damage report field 134 for recordation of any items damaged or lost in shipping. A footer 136 at the end of inventory document 124 provides space for a client signature at the origination site, and a client signature following delivery of items 52 (FIG. 2) at the destination site. Exemplary inventory document 124 is presented herein to illustrate how data entries 64 (FIG. 2) of linked ones of barcode identifiers 56 and data records 62 can be presented to a user, along with additional information pertaining to the client, verification of delivery of items, and recordation of damaged or lost items. However, those skilled in the art will recognize that inventory document 124 can take on many different configurations.

In summary, the present invention teaches of a portable data collection system that links a unique barcode identifier coupled to an item with a verbal description of the item. Voice signals corresponding to the item are interpreted by voice recognition software, and the system links these voice signals with the barcode identifier in a simply generated and highly accurate inventory database that can be readily incorporated into inventory management procedures employed by relocation companies. Such a system and method reduces the potential for inadvertent inventory errors and/or intentional fraud. The reduction in errors and fraud, potentially increases client satisfaction while, at the same time, achieves cost savings for the relocation company in terms of labor dollars spent and insurance claims filed.

Although the preferred embodiments of the invention have been illustrated and described in detail, it will be readily apparent to those skilled in the art that various modifications may be made therein without departing from the spirit of the invention or from the scope of the appended claims.

1. A portable data collection system for associating a barcode identifier with an item comprising:
a microphone for receiving voice signals identifying said item;
an optical scanner for reading said barcode identifier from a barcode label coupled to said item;
an actuator that concurrently actuates said optical scanner and enables receipt of said voice signals;
a microprocessor, in communication with each of said microphone, said optical scanner, and said actuator, said microprocessor executing a voice recognition program that interprets said voice signals to form a data record corresponding to said item; and
a memory element associated with said microprocessor for storing said data record linked with said barcode identifier.

2. A portable data collection system as claimed in claim 1 further comprising a handheld enclosure housing said optical scanner, said microprocessor, and said memory element.

3. A portable data collection system as claimed in claim 2 wherein said enclosure comprises a pistol grip handle.

4. A portable data collection system as claimed in claim 1 wherein said actuator comprises a manually actuated trigger extending through said enclosure.

5. A portable data collection system as claimed in claim 1 wherein:
said microphone is a wireless microphone that transmits said voice signals as a radio frequency signal; and
said data collection system comprises a receiver in communication with said microprocessor for receiving said radio frequency signal.

6. A portable data collection system as claimed in claim 5 wherein said microphone is a wireless headset microphone.

7. A portable data collection system as claimed in claim 1 wherein said voice signals further describe a condition of said item.

8. A portable data collection system as claimed in claim 1 further comprising a display in communication with said microprocessor.

9. A portable data collection system as claimed in claim 1 further comprising means for modifying said data record.

10. A portable data collection system as claimed in claim 9 further comprising:
a display in communication with said microprocessor for presenting said data record corresponding to said item; and
said modifying means includes a keypad operable by a user to move between characters of said data record displayed on said display and remove selected ones of said characters.

11. A portable data collection system as claimed in claim 1 further comprising a data port in communication with said memory element for outputting said data record linked with said barcode identifier to a remote device.

12. A portable data collection system as claimed in claim 1 wherein said memory element comprises a database for storing said data record, and said barcode identifier is an index to said data record.

13. A portable data collection system as claimed in claim 1 wherein said item is one of a plurality of items to be transported from an origination site to a destination site, said data collection system is used to generate a database at said origination site that includes an inventory of said plurality of items, and said database is utilized at said destination site to verify an arrival of said plurality of items.

14. A method for inventory management of a plurality of items utilizing a portable data collection system comprising:
generating, in a memory element of said data collection system, a database that includes an inventory of said plurality of items, said generating operation comprising for each of said plurality of items:
reading a barcode identifier from a barcode label coupled to said each item via an optical scanner of said data collection system;
receiving voice signals identifying said each item via a wireless microphone in radio frequency communication with said data collection system;
interpreting said voice signals at said data collection system by executing a voice recognition program to form a data record corresponding to said each item; and
storing said data record linked with said barcode identifier for said each item in said database; and
providing said database to a user for use in said inventory management.

15. A method as claimed in claim 14 wherein said reading and receiving operations occur concurrently.

16. A method as claimed in claim 14 wherein said voice signals further describe a condition of said each item.

17. A method as claimed in claim 14 wherein said each item is a first item and said generating operation further comprises:
detecting actuation of said reading operation for a next one of said plurality of items; and
discontinuing said receiving operation for said each item in response to said detecting operation.

18. A method as claimed in claim 14 wherein said generating operation further comprises presenting, on a display of said portable data collection system, said data record corresponding to said item.

19. A method as claimed in claim 18 wherein said presenting operation occurs concurrently with said interpreting operation.

20. A method as claimed in claim 18 further comprising enabling modification of said data record presented on said display via a keypad of said portable data collection system.

21. A method as claimed in claim 14 wherein said generating operation comprises outputting said database to a remote device.

22. A method as claimed in claim 14 wherein said plurality of items is to be transported from an origination site to a destination site, and said method further comprises:
performing said generating operation at said origination site; and
utilizing said database at said destination site to verify an arrival of said plurality of said items.

23. A portable data collection system for associating a barcode identifier with an item for inventory management, said system comprising:
a wireless headset microphone for receiving voice signals identifying said item and transmitting said voice signals as a radio frequency signal;
an optical scanner for reading said barcode identifier from a barcode label coupled to said item;
an actuator that concurrently actuates said optical scanner and enables receipt of said voice signals;
a receiver for receiving said radio frequency signal;
a microprocessor, in communication with each of said microphone, said optical scanner, said actuator, and said receiver, said microprocessor executing a voice recognition program that interprets said voice signals of said radio frequency signal to form a data record corresponding to said item;
a memory element associated with said microprocessor for storing said data record linked with said barcode identifier; and
a handheld enclosure housing said optical scanner, said microprocessor, and said receiver.

24. A portable data collection system as claimed in claim 23 wherein said actuator comprises a manually actuated trigger extending through said enclosure.

25. A portable data collection system as claimed in claim 23 further comprising:
a display in communication with said microprocessor for presenting said data record corresponding to said item; and
a keypad operable by a user to move between characters of said data record displayed on said display and remove selected ones of said characters to modify said data record.

26. A portable data collection system as claimed in claim 23 further comprising a data port in communication with said memory element for outputting said data record linked with said barcode identifier to a remote device.

27. A portable data collection system as claimed in claim 23 wherein said item is one of a plurality of items to be transported from an origination site to a destination site, said data collection system is used to generate a database at said origination site that includes an inventory of said plurality of items, and said database is utilized at said destination site to verify an arrival of said plurality of items.
